(19) United States
(12) Patent Application Publication
(10) Pub. No.: US 2011/0297125 A1
(43) Pub. Date: Dec. 8, 2011

(54) Reverse Flow Check Valve For Common Rail Fuel System

(75) Inventors: Scott F. Shafer, Morton, IL (US); Michael David Gerstner, Peoria, IL (US); Kenneth C. Adams, Dunlap, IL (US); Daniel Richard Ibrahim, Metamora, IL (US); Zhenyu Li, Peoria, IL (US); Benjamin Ray Tower, Varna, IL (US)

(73) Assignee: CATERPILLAR INC., Peoria, IL (US)

(21) Appl. No.: 12/792,874

(22) Filed: Jun. 3, 2010

(51) Int. Cl. F02M 63/02

(52) U.S. Cl. 123/456

(57) ABSTRACT

A common rail fuel system includes a reverse flow check valve fluidly positioned between each of a plurality of common rail fuel injectors and an outlet of a high pressure pump. The reverse flow check valves divide the overall system fluid volume into an upstream common volume and a plurality of separate downstream volumes. The upstream common volume is greater than the sum of the separate downstream volumes. The reverse flow check valve is movable between a first configuration with a large flow area and a second configuration with a small flow area. The reverse flow check valve associated with each of the individual fuel injectors may be housed in a quill that fluidly connects the fuel injectors to the high pressure common rail.

### TECHNICAL FIELD

The present disclosure relates generally to common rail fuel systems, and more particularly to a reverse flow check valve to inhibit pressure oscillations that undermine control over fuel injection events.

### BACKGROUND

During an injection event, high pressure fuel is rushing from the common rail toward the nozzle outlet of an individual fuel injector. When that injection event is abruptly terminated, a hydraulic hammer pressure wave can develop due to an abrupt stopping of the fluid momentum. This pressure wave will propagate from the fuel injector toward the common rail. Not only can this pressure wave produce pressure spikes within the fuel injector that can hasten structural fatigue, the pressure oscillations can also create difficulties in governing the quantity and timing of fuel delivered in close coupled post injections by the same injector. In addition, the pressure waves can propagate through the common rail and arrive at another fuel injector inlet when that fuel injector is initiating an injection event, which can result in that fuel injector injecting more or less than an expected fuel injection amount associated with its particular control signal.

In one apparent attempt accommodate pressure fluctuations in a common rail fuel system, Ganser et al. describe in paper number 70 of CIMAC Congress 2007, Vienna, Austria a fuel system that utilizes a wave dynamics and dampening system fluidly located between the high pressure pump and the fuel injectors. A single wave dynamics and dampening system supplies a pair of fuel injectors with high pressure fuel, and a plurality of the wave dynamics and dampening systems are connected in series to serve a bank of fuel injectors. Although the Ganser system may produce results that improve upon common rail fuel system with no strategy for dealing with pressure waves, substantial pressure fluctuations remain in the Ganser system at the injector inlet, which can lead to erratic fuel injection quantities, especially for close coupled post injections. The wave dynamics and dampening system of the Ganser fuel system includes a spring biased check valve that fluidly separates the individual injectors from the common rail. However, a majority of the Ganser high pressure fluid volume is located on the injector side of the wave dynamics and dampening check valve.

The present disclosure is directed toward one or more of the problems set forth above.

### SUMMARY OF THE DISCLOSURE

In one aspect, a common rail fuel system includes a high pressure pump with an outlet fluidly connected to a common rail. Each of a plurality of common rail fuel injectors is fluidly connected to the common rail. A reverse flow check valve is fluidly positioned between each of the plurality of common rail fuel injectors and the outlet of the high pressure pump. The common rail fuel system defines a system fluid volume between the outlet of the high pressure pump and a nozzle outlet of the plurality of fuel injectors. The reverse flow check valves divide the system fluid volume into an upstream common volume and a plurality of separate downstream volumes. The upstream volume is greater than a sum of the separate downstream volumes. The reverse flow check valve is movable between a first configuration with a large flow area, and a second configuration with a small flow area.

In another aspect, a method of operating a common rail fuel system includes generating a hydraulic hammer pressure wave in one of the common rail fuel injectors by closing the nozzle outlet to end a main injection event. The hydraulic hammer pressure wave is propagated toward the upstream common volume. The hydraulic hammer pressure wave is attenuated by moving the reverse flow check valve from the first configuration to the second configuration.

In still another aspect, a quill for a common rail fuel system includes a housing with a fluid passage extending between an inlet end and an outlet end The outlet end has a spherical tip sized and shaped to be received in sealing contact with a conical common rail inlet of a common rail fuel injector. The reverse flow check valve is positioned in the fluid passage of the quill.

### BRIEF DESCRIPTION OF THE DRAWINGS

FIG. 1 is a schematic illustration of a common rail fuel system according to one embodiment of the present disclosure;

FIG. 2 is an enlarged sectioned side view of one of the fuel injectors and quill from the fuel system of FIG. 1;

FIG. 3 is a pie chart showing how the system fluid volume for the fuel system of FIG. 1 is divided among different components of the fuel system;

FIG. 4 is a schematic view of a common rail fuel system according to another embodiment of the present disclosure;

FIG. 5 is a sectioned side view of one modular rail/quill and fuel injector for the fuel system of FIG. 4;

FIG. 6 is a pie chart showing the division of the system fluid volume among different components of the fuel system of FIG. 4;

FIG. 7 is a graph showing pressure dynamics of a base line common rail fuel system for a main plus post injection sequence;

FIG. 8 is a graph of pressure dynamics for the fuel system of FIG. 1 for comparison to the graph of FIG. 7; and

FIG. 9 is a graph of pressure dynamics for the fuel system of FIG. 4 for comparison with the graph of FIG. 7.

### DETAILED DESCRIPTION

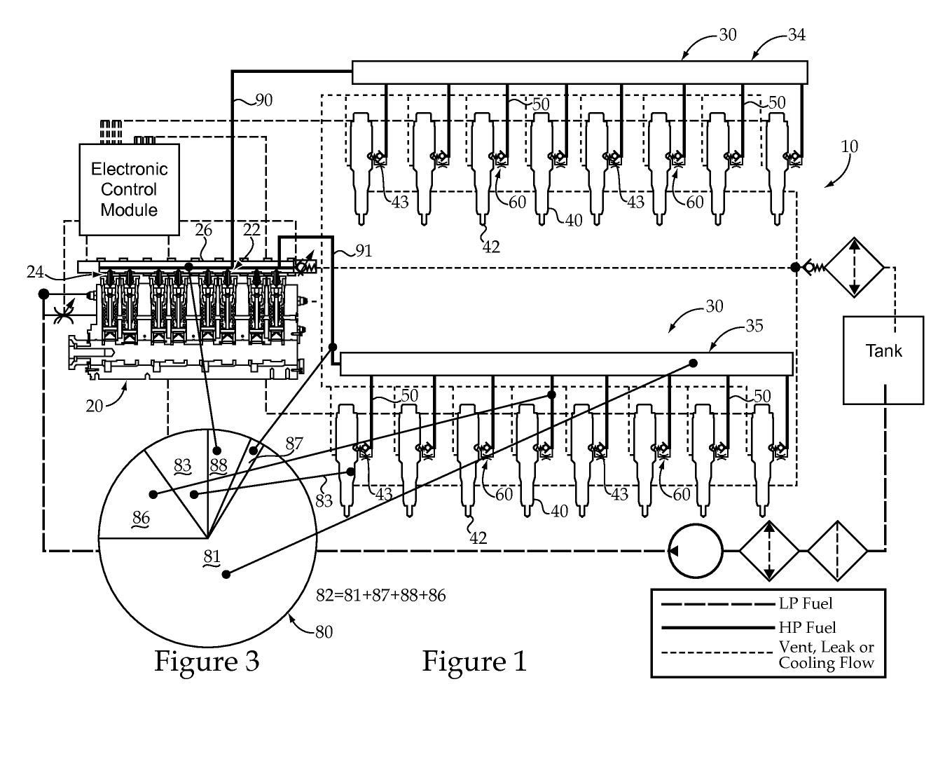

Referring now to FIG. 1, a common rail fuel system 10 includes a high pressure pump 20 with an outlet 22 fluidly connected to a common rail 30. The fuel system illustrated in FIG. 1 is associated with a sixteen cylinder compression ignition engine having a V-configuration, resulting in two banks of eight common rail fuel injectors. Those skilled in the art will appreciate that the concepts of the present disclosure are equally applicable to V-type and inline engines with any number of cylinders. High pressure pump 20 includes eight individual pumping elements such that outlet 22 actually comprises a plurality of outlets 24 that are fluidly connected to an output rail (manifold) 26. The common rail 30 includes a first injector rail 34 and a second injector rail 35 that are fluidly connected to the output rail 26 via first and second distribution passages 90 and 91, respectively. Each of a plurality of common rail fuel injectors 40 are fluidly connected to either the first or second injector rail 34 or 35 of common rail 30 via an individual quill 50. Each quill 50 is in sealing contact with a conical high pressure inlet 43 of an individual fuel injector 40. Each fuel injector 40 includes a nozzle outlet 42 positioned for direct fuel injection into an individual cylinder of a compression ignition engine (not shown).

A reverse flow check valve 60 is fluidly positioned between the nozzle outlet 42 of each of the common rail fuel injectors 40 and the outlet(s) 22 of the high pressure pump 20. The reverse flow check valves 60 operate to divide the overall system fluid volume 80 (FIG. 3) into an upstream common volume 82 and a plurality of separate downstream volumes 83. The reverse flow check valve 60 is movable between a first configuration with a large flow area associated with an injection event, and a second configuration with a small flow area associated with equalizing upstream & downstream pressures between injection events. The overall system fluid volume 80 includes the output volume 88 associated with the output rail 26, a distribution volume 87 associated with the first and second distribution passages 90 and 91, a common rail volume 81 associated with the first and second injector rails 34 and 35, a quill volume 86 associated with the sum of the individual quill volumes 50 and the separate downstream volumes 83 associated with the sum of the separate fluid volumes downstream from the individual reverse flow check valves 60. A majority of the separate downstream volumes 83 being the fluid volume within the individual fuel injectors 40 when the reverse flow check valve 60 is located in close proximity to the conical high pressure inlets 43 as shown in FIG. 1. In accordance with the present disclosure, the upstream common volume 82 is greater than the sum of the separate downstream volumes 83.

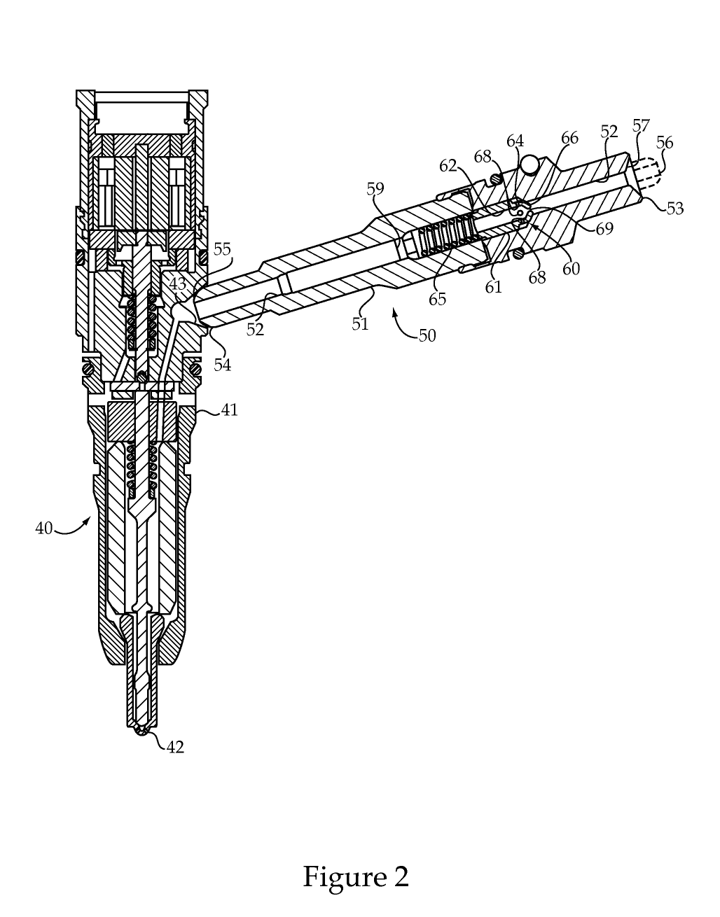

Referring now to FIG. 2, an enlarged view of one of the fuel injectors 40 for the fuel system of FIG. 1 is shown with its associated quill 50. Thus, in the fuel system of FIG. 1, each reverse flow check valve 60 is located outside the associated injector body 41, but the present disclosure contemplates common rail fuel systems in which the reverse flow check valve is incorporated into the fuel injector 40. The quill 50 includes a housing 51 with a fluid passage 52 extending between an inlet end 53 and an outlet end 54. The outlet end 54 has a spherical tip 55 for engaging in sealing contact with the conical high pressure inlet 43 of an individual fuel injector 40. Those skilled in the art will appreciate that the present disclosure also contemplates other quill sealing structures, including but not limited to differential angle male conical and female conical, as well as flat and bite edge style sealing arrangements. The reverse flow check valve 60 is positioned in the fluid passage 52. Depending upon the construction of the injector rail 34 and 35, the inlet end 53 of the quill 50 may include a spherical surface 56 or a conical surface 57 for engaging in sealing contact with an other of a spherical surface and a conical surface associated with an injector rail 34 or 35. In the illustrated embodiment, the injector rails 34 and 35 include a spherical surface that engages with the conical surface 56 at the inlet end 53 of the individual quills 51. Although not necessary, the individual quills 50 may also include an edge filter 59.

The reverse flow check valve 60 includes a valve member 61 that is biased into contact with a seat 64 by a spring 65. The valve member 61 defines a flow passage 62 with a small flow area 69 through its center. However, when high pressure acts upon a opening hydraulic surface 66, such as during an injection event, valve member 61 moves off of the seat 64 to reveal a large flow area 68. Thus, when valve member 61 is moved off of seat 64, a large flow area consists of flow past the seat 64 and through side passages defined by valve member 61 into a central flow passage 62. When valve member 61 is in contact with seat 64, such as between injection events, the upstream and downstream segments of flow passage 52 are fluidly connected via the small flow area 69 defined by valve member 61. Thus, the reverse flow check valve 60 can be considered to be movable between a first configuration with a large flow area when valve member 61 is off seat 64, and a second configuration associated with a small flow area 69 when valve member 61 is in contact with seat 64. The opening hydraulic surface 66 is oriented in opposition to spring 65, as shown. Thus, the valve member 61 is biased via the preload in spring 65 toward the second configuration.

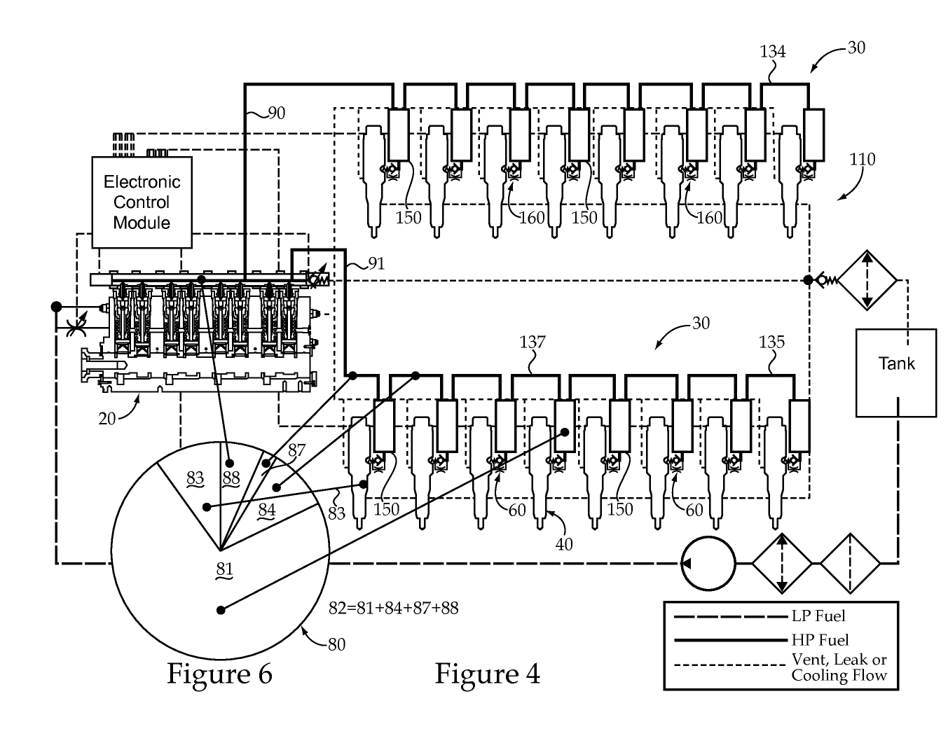

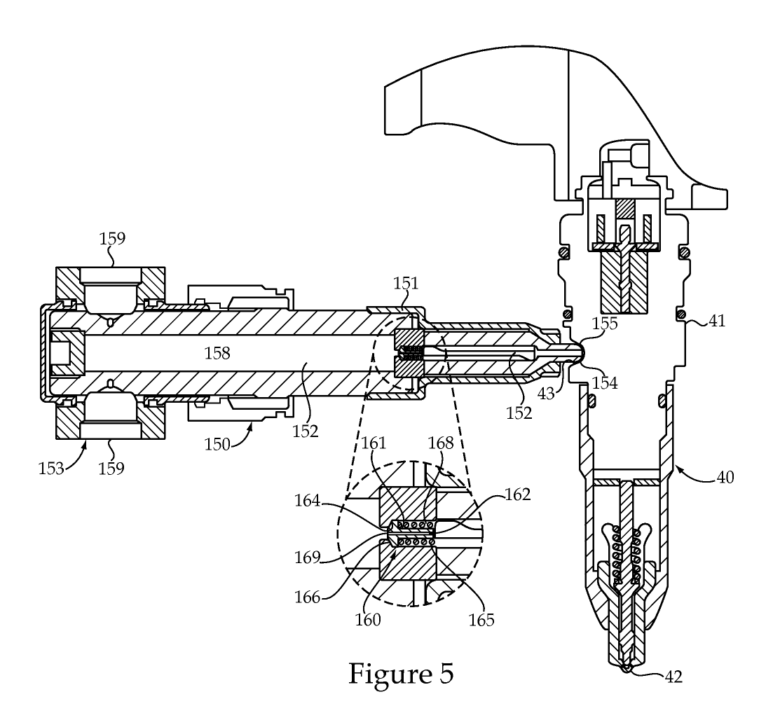

Referring now to FIG. 4, a common rail fuel system 110 is very similar to the common rail fuel system 10 associated with FIG. 1 except that the first and second injector rails 134 and 135 are divided into a plurality of modular rail/quills 150 that are fluidly connected in series via modular rail connection passages 137. The modular rail/quills (accumulators) 150 include a housing 151 with a fluid passage 152 extending between an inlet end 153 and an outlet end 154. Similar to quill 50, modular rail/quills 150 include a spherical tip 155 at its outlet end 154 for being received in a conical high pressure inlet 43 of an individual fuel injector 40. Modular rail/quill 150 differs from quill 50 earlier discussed in that inlet end 153 includes a pair of distribution ports 159 that allow adjacent modular rail quills to be fluidly connected in series via modular rail connection passage 137 as shown in FIG. 4.

A reverse flow check valve 160 may be positioned in fluid passage 152. The reverse flow check valve 160 includes a valve member 161 that is biased by a spring 165 into contact with a seat 164. The valve member 161 defines a flow passage 162 therethrough that includes a small flow area 169. However, when valve member 161 is moved off of its seat 164 during an injection event, a large flow area includes flow around the outside of valve member 161 and through its center passage. The upstream segment of fluid passage 52 includes an elongated cylindrically shaped volume of fluid 158. The elongated cylinder shape fluid volumes 158 of adjacent modular rail/quills 150 are arranged in parallel to one another. The combined modular volumes 85 associated with the elongated cylindrical shaped volume 58 are comparable to the common rail volume 81 associated with the fuel system 10 shown in FIG. 1. As with the fuel system associated with FIG. 1, the fuel system 110 shown in FIG. 4 consists of the output volume 88 associated with the output rail 26 of the high pressure pump 20, a distribution volume 87 associated with the distribution passages 90 and 91, a modular volume 85 associated with the sum of the modular volumes, a connection volume 84 associated with the connection passages 137, and the separate downstream volumes 83 that represent the fluid volume within the fuel injector and that portion downstream from the reverse flow check valves 160. Thus, the reverse flow check valves 160 separate the system fluid volume 80 into an upstream common volume 82 and a plurality of separate downstream volumes 83. The upstream common volume 82 consists of the combined modular volume 85, plus the connection passage volume 84, plus the distribution volume 87 plus the output volume 88. As with the previous embodiment, the upstream common volume 82 is greater than the sum of the separate downstream volumes 83, and constitutes a majority of the overall system fluid volume 80.

### INDUSTRIAL APPLICABILITY

The reverse flow check valve 60, 160 of the present disclosure finds potential application in any common rail fuel system. The reverse flow check valve 60, 160 of the present disclosure finds specific applicability in common rail fuel systems for compression ignition engines in which rail pressures can reach 250 MPa or higher but lower pressure systems could also benefit from the teachings of this disclosure. The present disclosure is not merely associated with the inclusion of a reverse flow check valve in a common rail fuel system, but instead how that reverse flow check valve is incorporated into the division of the system fluid volume 80 in the common rail fuel system 10, 110. The present disclosure recognizes that reduction of pressure overshoot and pressure oscillations is very sensitive to the location of the reverse flow check valve 60, 160 relative to the volumes in the fuel system 10, 110. The present disclosure teaches that the reverse flow check valve 60, 160 should be located between the largest volume of the fuel system and the smaller volume associated with the fuel injector internal high pressure volume. The reverse flow check valve 60, 160 must be located downstream of a preponderance of the overall system fluid volume 80, and of course upstream from the nozzle check valve seat of the fuel injector 40. Correct placement of the reverse flow check valve relative to the volumes in the fuel system can greatly reduce pressure overshoots internal to the injector and in the remainder of the system 10, 110 to improve cylinder to cylinder fueling pressure, quantity and timing control, and improve flexibility and control of all fuel injections, especially close coupled post injections. The improvements provided by the present disclosure are specifically applicable to fuel systems delivering as much as 15,000 cubic millimeters of total fueling per injection sequence, and is inclusive of heavy fuel oil common rail fuel systems as well as those associated with distillate diesel fuel.

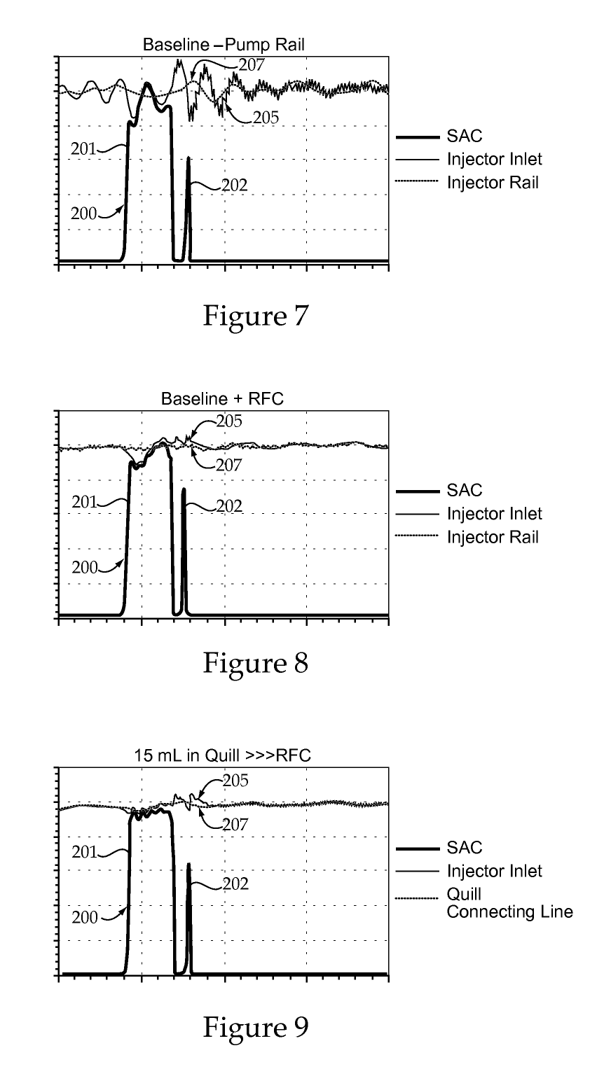

Referring now to FIGS. 7, 8 and 9, identical graphs are utilized to illustrate the differences in behavior between the fuel system 10 (FIG. 8) and 110 (FIG. 9) relative to a substantially identical fuel system with no reverse flow check valve as illustrated in FIG. 7. Each of the graphs show an injection sequence 200 that includes a main injection event 201 and a close coupled post injection 202. The injection sequence 200 is illustrated in association with the sac pressure within an individual fuel injector 40. Those skilled in the art will appreciate that the sac is that small volume near the tip of a fuel injector and below the nozzle valve seat that all of the nozzle outlets open into. Graphs 7, 8 and 9 also show the pressure 205 at the injector inlet, as well as the injector rail pressure in the common rail 30. The graph of FIG. 7 is of interest for showing that the common rail pressure 207 fluctuates due to previous pressure waves continuing to bounce around (oscillate) in the system volume prior to being dissipated. FIG. 7 is also of interest for showing that the pressure at the injector inlet varies substantially both prior to, and immediately after, the main injection event 201 and the post injection event 202. These pressure fluctuations would reveal themselves as uncertainty in the injection quantity associated with the close coupled post injection, variation in injection quantities among the different fuel injectors, and other fueling variations and their associated problems known in the art. On the other hand, the graphs of FIGS. 8 and 9 show that the rail pressure 207 remains substantially steady both before, during and after the injection sequence 200. In addition, the pressure at the injector inlet 205 shows a predictable shape as it relates to the close coupled post injection 202, and quickly damps out thereafter. By recognizing and compensating for the predicted shape of the pressure fluctuation 205, the close coupled post injection can be tightly controlled in both quantity and timing with reduced variation relative to the system associated with FIG. 7 that includes no reverse flow check valve. The graph of FIG. 9 is similar to that of FIG. 8 except that the rail pressure 207 represents the pressure in the modular rail/quills 150 in the elongated cylindrical volume 158.

When the common rail fuel systems 10, 110 are in operation, the nozzle outlet 42 for one of the fuel injectors 40 will open to allow fuel to spray into one of the combustion chambers of the associated engine. For instance, the injection may be a portion of a main injection event 201 as shown in FIGS. 8 and 9. As the injection flow rate builds, the fuel will act on the opening hydraulic surface 66, 166 of the reverse flow check valve and move it from its second configuration with the small flow area 69, 169 through the valve member 61, 161, to the first configuration with a larger flow area 68, 168. When the injection event is ended, the nozzle outlet 42 will abruptly close and the flow toward the nozzle outlet 42 will come to an abrupt stop, which may generate a hydraulic hammer pressure wave in the fuel injector 40. As the pressure wave propagates toward the common rail 30, the pressure wave and/or the pre-load of spring 65, 165 will cause the reverse flow check valve 60, 160 to move from its first configuration to its small flow area second configuration. When this is done, the small flow area 69, 169 substantially isolates the upstream common volume from the pressure wave and serves to attenuate the pressure wave. This is revealed in the graphs of FIGS. 8 and 9 by the common rail pressure 207 remaining substantially steady immediately after the main injection event 201. The reverse flow check valve 60, 160 also serves to attenuate the pressure at the injector inlet as shown by the curve 205 in FIGS. 8 and 9. As used in this disclosure, attenuate means attenuated relative to an equivalent fuel system with no reverse flow check valve, such as that illustrated in the graphs of FIG. 7. In other words, the pressure fluctuations in the fuel systems 10 and 110 as shown by the graphs of FIGS. 8 and 9, respectively, are attenuated relative to the fluctuations shown in the equivalent fuel system with no reverse flow check valve as graphed in FIG. 7.

The preload on the spring 65, 165 should be chosen such that the valve member 61, 161 tends to remain in contact with seat 64, 164 rather than bounce off the same to allow the pressure wave to escape, and the preload should be sufficiently low that the injection pressure at the nozzle outlet is only slightly lower than the pressure in the common rail. Thus, the spring should be sufficiently strong that the reverse flow check valve 60, 160 is reliably maintained in the second small flow area configuration between injection events, but does not substantially interfere with flow to the injector during injection events. In addition, the size of the small flow area 69, 169 should be sufficiently large that the pressures on opposite sides of the reverse flow check valve 60, 160 can equalize between injection events but sufficiently small that the propagating hydraulic hammer pressure wave is choked off or attenuated, and maybe even prevented, from reaching the upstream common volume of the common rail fuel system 10, 110. If the small flow area, 69, 169 is too small or eliminated all together, one could expect uncertain pressures to be trapped between the reverse flow check valve and the nozzle outlet 42 of the fuel injector, creating great uncertainty for subsequent injection events, especially closed coupled post injection events 202 of the type illustrated in FIG. 7-9. Thus, the small flow area 69, 169 should be sufficiently large that pressure does not become trapped between the reverse flow check valve and the fuel injector, or be too large that the hydraulic hammer pressure wave is not sufficiently attenuated. On the otherhand, the small flow area 69, 169 should be sufficiently large that pressures on opposite sides of the reverse flow check valve 60, 160 can quickly equalize between injection events.

Although not readily apparent, pressure fluctuations within the fuel systems 10, 110 is also damped in the case of a high pressure pump with multiple pumping elements by collecting the outputs from the respective pumping elements in a common output rail 26 prior to distributing the same to the injector rails 34, 134 and 35, 135. Damping means damped relative to an equivalent system with no intermediate output rail separating the pump outlets from the common rail. Thus, the distribution passages 90 and 91 also serve to isolate the injector rails 34, 134 and 35, 135 from some of the pressure waves originating from the high pressure pump 20. This is also revealed in the graphs of FIGS. 8 and 9 by the near constant steady pressure 207 in the common rail 30. Returning to the injection sequence, after a brief dwell time, a close coupled post injection event is initiated by again opening the nozzle outlet 42 of the fuel injector 40. A short time thereafter, the nozzle outlet 42 is again closed. During this time, the reverse flow check valve moves from its second small flow area configuration to its first large flow area configuration, and quickly back to the second configuration at the end of the injection sequence.

It should be understood that the above description is intended for illustrative purposes only, and is not intended to limit the scope of the present disclosure in any way. Thus, those skilled in the art will appreciate that other aspects of the disclosure can be obtained from a study of the drawings, the disclosure and the appended claims.

What is claimed is:

1. A common rail fuel system comprising:
a high pressure pump with an outlet fluidly connected to a common rail;
each of a plurality of common rail fuel injectors being fluidly connected to the common rail;
a reverse flow check valve fluidly positioned between each of the plurality of common rail fuel injectors and the outlet of the high pressure pump;
the common rail fuel system defining a system fluid volume between the outlet of the high pressure pump and a nozzle outlet of the plurality of fuel injectors, and the reverse flow check valves divide the system fluid volume into an upstream common volume and a plurality of separate downstream volumes;
the upstream common volume being greater than a sum of the separate downstream volumes; and
the reverse flow check valve is movable between a first configuration with a large flow area and a second configuration with a small flow area.

2. The common rail fuel system of claim 1 wherein each of the reverse flow check valves are located outside an injector body of an associated one of the plurality of common rail fuel injectors.

3. The common rail fuel system of claim 2 wherein the reverse flow check valve is biased with a spring toward the second configuration, but including an opening hydraulic surface oriented in opposition to the spring.

4. The common rail fuel system of claim 3 wherein each of the common rail fuel injectors includes a conical high pressure inlet;
a plurality of quills that each include a spherical tip in contact with the conical high pressure inlet of one of the plurality of common rail fuel injectors; and
each of the reverse flow check valves being positioned in one of the quills.

5. The common rail fuel system of claim 4 wherein the reverse flow check valve includes a valve member in contact with the spring; and
the valve member defines a flow passage therethrough that defines the small flow area.

6. The common rail fuel system of claim 5 wherein each of the quills has an inlet end opposite to the spherical tip; and
the inlet end includes one of a spherical surface and a conical surface shaped to be received into contact with an other of the spherical surface and the conical surface located on an injector rail.

7. The common rail fuel system of claim 5 wherein each of the quills is a portion of a modular rail that defines a modular volume;
the system fluid volume including the modular volumes;
a sum of the modular volumes being a majority of the system fluid volume.

8. The common rail fuel system of claim 7 wherein each of the modular volumes has an elongated cylindrical shape oriented in parallel with an adjacent one of the modular volumes.

9. The common rail fuel system of claim 1 wherein the outlet of the high pressure pump includes a plurality of outlets that are fluidly connected to an output rail that has an output volume that is a portion of system fluid volume.

10. The common rail fuel system of claim 9 wherein the common rail includes a first common rail and a second common rail fluidly connected to the output rail by first and second distribution passages, respectively.

11. The common rail fuel system of claim 10 wherein each of the first and second common rails includes a plurality of modular rails; and
each of the modular rails supplies fuel to one of the common rail fuel injectors.

12. A method of operating a common rail fuel system that includes a high pressure pump with an outlet fluidly connected to a common rail, which is fluidly connected to a plurality of common rail fuel injectors; and a reverse flow check valve fluidly positioned between each of the plurality of common rail fuel injectors and the outlet of the high pressure pump; and the common rail fuel system defining a system fluid volume between the outlet of the high pressure pump and a nozzle outlet of the plurality of fuel injectors; and the reverse flow check valves divide the system fluid volume into an upstream common volume and a plurality of separate downstream volumes; and the upstream common volume is greater than a sum of the separate downstream volumes; and the reverse flow check valve is movable between a first configuration with a large flow area and a second configuration with a small flow area, the method comprising the steps of:
generating a hydraulic hammer pressure wave in one of the common rail fuel injectors by closing the nozzle outlet to end a main injection event;
propagating the hydraulic hammer pressure wave toward the common volume; and
attenuating the hydraulic hammer pressure wave by moving the reverse flow check valve from the first configuration to the second configuration.

13. The method of claim 12 including a step of equalizing pressure in the common volume with the separate downstream volumes between injection events by fluid communication through the small flow area of the reverse flow check valve.

14. The method of claim 13 including a step of generating a pump pressure wave by moving fuel through the outlet of the high pressure pump;
propagating the pump pressure wave toward the common rail fuel injectors; and
damping the pump pressure wave by fluidly separating the common rail from the outlet of the high pressure pump by an output rail and a distribution passage.

15. The method of claim 14 including a step of pressurizing the common rail to a pressure of at least 250 MPa.

16. The method of claim 15 including a step of performing a close coupled post injection a brief dwell time after the main injection event by moving the reverse flow check valve from the second configuration to the first configuration; and
ending the close coupled post injection event; and
moving the reverse flow check valve back to the second configuration after ending the close coupled post injection event.

17. A quill for a common rail fuel system that includes a high pressure pump with an outlet fluidly connected to a common rail, which is fluidly connected to a plurality of common rail fuel injectors by individual quills; and a reverse flow check valve fluidly positioned between each of the plurality of common rail fuel injectors and the outlet of the high pressure pump; and the common rail fuel system defining a system fluid volume between the outlet of the high pressure pump and a nozzle outlet of the plurality of fuel injectors; and the reverse flow check valves divide the system fluid volume into an upstream common volume and a plurality of separate downstream volumes; and the upstream common volume is greater than a sum of the separate downstream volumes; and the reverse flow check valve is movable between a first configuration with a large flow area and a second configuration with a small flow area, the quill comprising:
a housing with a fluid passage extending between an inlet end and an outlet end;
the outlet end having a spherical tip sized and shaped to be received in sealing contact with a conical common rail inlet of one of the common rail fuel injectors; and
the reverse flow check valve being positioned in the fluid passage.

18. The quill of claim 17 wherein the reverse flow check valve is biased with a spring toward the second configuration, but including an opening hydraulic surface oriented in opposition to the spring.

19. The quill of claim 18 wherein the inlet end includes one of a spherical surface and a conical surface shaped to be received into contact with an other of the spherical surface and the conical surface located on an injector rail.

20. The quill of claim 18 wherein the fluid passage includes an elongated cylindrical modular rail that defines a modular volume and is located between the inlet end and the reverse flow check valve; and
the inlet end includes a pair of distribution ports.
